(19) United States
(12) Patent Application Publication
(10) Pub. No.: US 2004/0010443 A1
(43) Pub. Date: Jan. 15, 2004

(54) Method and financial product for estimating geographic mortgage risk

(76) Inventors: Andrew W. May, Greensboro, NC (US); Aaron Medvick, Greensboro, NC (US); Maruthy K. Pannala, Greensboro, NC (US); Paul Imura, Cary, NC (US)

Correspondence Address: PROSKAUER ROSE LLP, PATENT DEPARTMENT, 1585 BROADWAY, NEW YORK, NY, 10036-8299, US

(21) Appl. No.: 10/428,727

(22) Filed: May 2, 2003

Related U.S. Application Data
(60) Provisional application No. 60/377,686, filed on May 3, 2002.

(51) Int. Cl. G06F 17/60

(52) U.S. Cl. 705/10

(57) ABSTRACT

A quarterly index projects geographic market risk for 200 MSAs over the next four to eight quarters. The index ratings use a grading scale that ranges from 1 to 10. A score of 1 indicates that an MSA is very unlikely to experience further decline in the model variables, which include home prices, local economy, population stability, and mortgage delinquency trends. A grade of 10 indicates the greatest chance for future decline. For example, a score of a 10 would indicate that it would be a good time to pull out of a market; whereas, a score of a 1 indicates a market that is a good investment.

### RELATED APPLICATIONS

This application claims the benefit of U.S. provisional patent application Ser. No. 60/377,686, filed May 3, 2002, entitled Method And Financial Product For Estimating Geographic Mortgage Risk. The contents of this provisional application are incorporated herein by reference.

### FIELD OF THE INVENTION

The inventive financial product (hereinafter known as the “inventive index,” “index”) is a geographic mortgage risk index that is designed to represent the estimated economic risk associated within a geographic area, which may be a particular metropolitan statistical area (“MSA” or “metro area”), a region of the country, or the entire country. In the index, a “score” or “rating” is determined for each geographic area. The model used to generate the index focuses on charts, trends, rankings, and relative analysis that identify an MSA's economic direction relative to the rest of the country. This enables national MSA rankings and individual risk gradients that take into account four classes of variables: [1] home prices, [2] local economy, [3] stability, and [4] mortgage delinquency rates.

### BACKGROUND OF THE INVENTION

Many financial companies provide market information services, such as compiling market information and offering their predictions of how the market will perform. The following describes some of the existing market information services and their deficiencies.

1. GE National Market Trends

GE National Market Trends offered by the General Electric Mortgage Corporation provides an explanation of the economy and what is going on in the regional and local housing markets. It has listings of employers and industries and graphs the economic indicators. GE National Market Trends balances MSA and state level data concerning employment, household, and real estate metrics. Every unit of change in rank over time represents a doubling of the loss frequency for comparable mortgages. A final rating on a scale of 1 to 5 takes an OmniMarket score in conjunction with local market knowledge.

The data can be accessed on a web site that offers graphs for nationwide data and graphs and lists for MSA data. These graphs include: national graphs for Housing Permit Growths, Median Existing Home Price, 12 Month Job Growth, Unemployment Rate, Personal Income Growth, Consumer Confidence Index, Debt Service Burden, Gross Domestic Product; and MSA graphs and lists for Affordability Index (MSA vs US), Median Sales Price, Delinquency Rate 60 Days Past Due, Employment Growth, Unemployment Rate, Existing Home Sales (MSA vs US), Household Formations, Housing Permits, Major Industries, and Top Employers.

2. MGIC Market Trend Analysis

MGIC Investment Corp. of Milwaukee, Wis. provides market trend analysis reports that provide an explanation of the economy and what is going on in the housing market. It has a chart of industries and graphs the economic indicators. The projection is either no change, stabilizing, softening or improving.

MGIC Market Trend Analysis reports include housing market conditions, current conditions and short-term projections. An overall picture of the economic health in each MSA is obtained by analyzing six of these major economic variables: Income Trend (Personal vs Salary), Employment, Unemployment, Housing Affordability, Median Sales Price Change, Industry Employment Share, Single Family Permits, and Household Growth. Markets are rated as soft, stable or strong.

MGIC Market Trend Analysis has alphabetically-ordered “current ratings” and “projections” for all MSAs in their study. MGIC offers MSA graphs and lists for the following: Income Trend (Personal vs Salary), Employment, Unemployment, Housing Affordability, Median Sales Price Change, Industry Employment Share, Single Family Permits, Household Growth.

3. Local Market Monitor National Review of Real Estate Markets Online

Local Market Monitor National Review of Real Estate Markets Online (of Wellesley, Mass.) has market information for approximately 160 MSAs. The national information indicates whether it is a time to buy or sell in the MSA and ranks the top over-priced markets. The information for each MSA includes a detailed summary and economic charts.

Local Market Monitor National Review of Real Estate Markets Online provides advice to institutions and investors involved in the buying, selling, financing, and construction of residential real estate. Its customers include REITs, investment bankers, mortgage bankers, home builders, financial advisors, commercial banks, savings banks, pension funds and sophisticated individual investors. It rates and ranks top MSA performers in the economy.

Local Market Monitor National Review of Real Estate Markets Online has the alphabetically-ordered lists with nationwide information for “residential risk return rankings”, “home value ratings”, “investment risk premiums”, “foreclosure risk ratings”, “economic growth rates”, “new housing permits issued”, and “economic growth potential”. The service also provides the following graphs and lists, by MSA: Population Growth (MSA vs US), Equilibrium vs Actual Home Prices (MSA vs US), Population Age Distribution, Housing Construction Balances, 24 Month Home Price Increase, Job Growth (MSA vs US), Job Growth Rates (MSA vs US), Employment Growths, Table of Economic Information, New Housing Permits, Home Sales, Structure of Housing Market, Vacancy Rates, Annual Home Sales by Price Range.

4. PMI Economic and Real Estate Trends

The PMI Group, Inc. publishes PMI Economic and Real Estate Trends (ERET), which includes commentary on the national economy and regional housing price trends. Additionally, Metropolitan Area Economic Indicators are provided for the 50 most populated metropolitan areas are, based on a statistical model utilizing economic and real estate variables with market expertise. The model provides several risk measures to gauge relative residential lending risk.

PMI Economic and Real Estate Trends ranks only the top 50 MSAs with a market rating of High, Medium or Low. It predicts the possibility that a MSA will suffer a deep and prolonged regional recession that results in such substantial home price declines that homeowners no longer have a positive equity interest in their homes. PMI's report displays risk index and the probability of decline. On a nationwide basis, PMI provides a National printout only (not on a statewide basis). Lists are also provided on an MSA basis for Probability of Decline, Risk Index, Home Price Appreciation, Employment Growth, Unemployment Rate.

5. RFA Regional Financial Review and Precis Metro/Macro

RFA (now known as Economy.com) provides the RFA Regional Financial Review. This review offers in-depth analysis of topical issues highly relevant to business planning. Recent analysis pieces include Economy.com's exclusive cost of doing business and cost of living indexes; numerous articles on e-tailing and e-commerce; the mortgage credit outlook; an examination of risk-adjusted returns by industry; and the international economic outlook. The Review also offers analysis and an extensive array on statistics on state and metropolitan area growth trends. One of the Review's regular features is an extensive discussion of major developments and changes to short-term forecasts for states and metropolitan areas. This is supplemented by over 60 tables offering historical statistics for states and metro areas on an array of subjects.

Each report covers a single metropolitan area in detail and includes five-year forecasts of gross metro product, employment, income, population, housing activity, migration flows, and personal bankruptcies. Written analysis details the metropolitan area's recent economic performance and short and long-term outlooks. Each area's strength and weaknesses and forecast risks are also detailed. Accompanying statistical tables cover top employers, industrial diversity, migration flows, leading industries, house prices, and income and earnings trends. The report includes Economy.com's exclusive metro area rankings for the cost of doing business, cost of living, risk-adjusted return, and short and long-term employment growth. Each report includes regional and national overviews, forecast assumptions, metro area ranking tables for all MSAs, forecast tracking, and user's guide.

Standard chapters in each national report include a U.S. overview, and information on regional economies, financial and international markets, labor markets and prices, agriculture, business investment, consumers, energy, housing, federal government, and forecast risks. Each chapter includes extensive written analysis and four charts with commentary. Recent performance tables show most recent data points for approximately 250 economic and financial concepts.

Each MSA report covers a single metropolitan area in detail and includes five-year forecasts of gross metro product, employment, income, population, housing activity, migration flows, and personal bankruptcies. Written analysis details the metro area's recent economic performance and short and long-term outlooks. Each area's strength and weaknesses and forecast risks are also detailed. Accompanying statistical tables cover top employers, industrial diversity, migration flows, leading industries, house prices, and income and earnings trends. The report includes Economy.com's exclusive metropolitan area rankings for cost of doing business, cost of living, risk-adjusted return, and short and long-term employment growth. Each report includes regional and national overviews, forecast assumptions, metropolitan area ranking tables for all MSAs, forecast tracking, and user's guide.

None of these prior art market information services companies offer a relative scoring method that utilizes variables that satisfy the mean reversion principle to generate an Index which is designed to forecast future economic conditions in a particular MSA, region, or country. Moreover, no other companies offer such a rating with a 1 -10 scale for market analyses nor do they also provide a similar scoring method for segments of the market by home prices, local economy, demographic stability, or mortgage delinquency rates.

### SUMMARY OF THE INVENTION

It is an object of the invention to overcome these and other deficiencies in the prior art.

A method and financial product are provided in accordance with the present invention for rating a geographic area by an inventive index market rating. This rating or score rates a geographic area, such as a metro area (MSA), on a scale from 1 to N, where 1 is the lowest indication of default risk and N is the highest. In one example, N=10. The score rates the economy of the metro area based on its current performance as compared to its past performance. The score depicts what the market is like now and what to expect within the next several quarters. For example a score of 10 would indicate that it might be a good time to pull out of a market; whereas, a score of a 1 indicates a market that has a low risk of future decline.

To generate the score, the Index ranks the MSAs against one another for variables representing different economic sectors of each MSA and combines the sector scores into one overall score. The purpose of the relative ranking and rating is to determine what are the best MSAs in which to invest. The Index Score thus distinguishes which MSAs would be better investments out of all the markets.

### BRIEF DESCRIPTION OF THE DRAWINGS

In the drawings, wherein like reference numerals denote similar elements through out the several views:

FIG. 1 schematically illustrates a flowchart of the overall steps in generating the inventive Index scores for metro areas and making these scores available in a report;

FIG. 2A depicts an index score and an MSA trend for an MSA, and a graph which shows an example of historical and current Index scores over time in accordance with a first embodiment of the invention;

FIG. 2B is a table which shows examples of index scores of individual economic sectors for the MSA of FIG. 2A in accordance with the first embodiment of the invention;

FIG. 2C is a table depicting data for home price appreciation, unemployment, income, and employment data for the MSA of FIG. 2A and comparable U.S. averages in accordance with the first embodiment of the invention;

FIG. 3A is a graph which shows home price appreciation for the MSA of FIG. 2A over time;

FIG. 3B is a graph which shows the unemployment rate for the MSA of FIG. 2A over time;

FIG. 3C is a graph which shows income appreciation for the MSA of FIG. 2A over time;

FIG. 3D is a graph which shows employment changes for the MSA of FIG. 2A over time;

FIG. 4A depicts an index score for an MSA, and a graph which shows an example of historical and current Index scores over time in accordance with a second embodiment of the invention;

FIG. 4B is a table which shows examples of index scores of individual economic sectors for the MSA of FIG. 4A in accordance with the second embodiment of the invention;

FIG. 4C is a table depicting data for home price appreciation, unemployment, income, and employment data for the MSA of FIG. 4A and comparable U.S. averages in accordance with the second embodiment of the invention;

FIG. 5A is a graph which shows home price appreciation for an MSA of FIG. 4A over time;

FIG. 5B is a graph which shows the unemployment rate for the MSA of FIG. 4A over time;

FIG. 5C is a graph which shows income appreciation over time for the MSA of FIG. 4A;

FIG. 5D is a graph which shows employment changes over time for the MSA of FIG. 4A;

FIGS. 6A, 6B, 6C and 6D illustrate a sample report alphabetically listing MSAs according to the inventive Index;

FIGS. 7A, 7B, 7C and 7D illustrate a sample report listing MSAs by their index scores for a particular economic sector;

FIG. 8 groups states in the United States by determining index scores for each states based on MSAs in the state;

FIG. 9 illustrates a map showing geographically the risk categories in various states as shown in FIG. 8; and

FIG. 10 depicts a computer on which the inventive model of the present invention, including the determination of the inventive indices and the generation of reports thereof, may be implemented.

### DETAILED DESCRIPTION OF THE PREFERRED EMBODIMENTS

An analysis of mortgage delinquency reveals patterns that several different economic and market conditions are associated with high mortgage default rate. These conditions are represented by the economic performance in four key “economic sectors” or classes that reflect the underlying strengths and weaknesses in an MSA. The four economic sectors are:

(i) Home prices—which are a measure of the movement of single-family house prices in an MSA. The component of this sector is the home price index.

(ii) Local economy—which is a measure of income levels, unemployment rates, and industry diversity in an MSA. Diversity is the ratio of an MSA's employment distributed among industries compared to the national employment distribution among industries;

(iii) Demographic stability—which measures population patterns of the MSAs. This reflects the persistence in an MSA of a population that purchases homes (e.g. total population and the population in the age bracket 25-44); and

(iv) Mortgage delinquency—which includes the ratio of loans reported to be 60 or more days past due to all loans serviced, not seasonally adjusted.

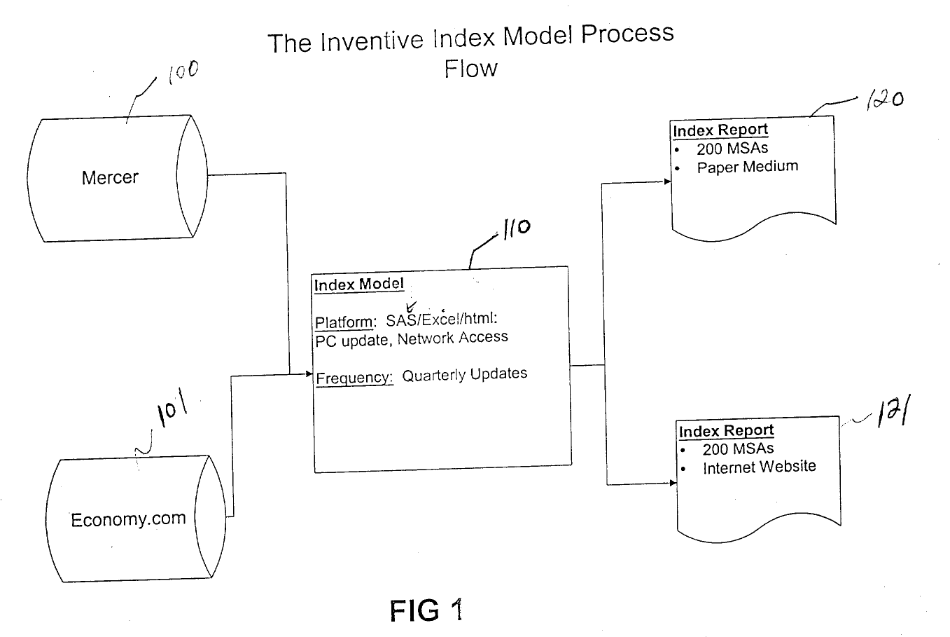

FIG. 1 illustrates a flow chart for the inventive index model of the present invention. The model is used to calculate a score by economic sector and an overall Index score for all of these economic sectors for each metropolitan statistical area (MSA) of interest. The objective is to create a numerical score that can be used to compare the risk in different MSAs.

A score for each economic sector and an overall index score for each MSA is determined based upon a host of variables that reflect these four sectors of the economy and, thereby reflect economic conditions for particular MSAs. Thus, as shown in FIG. 1, data sources for these variables are selected from data compiled by companies such as Mercer 100, Economy.com 101, and other sources such as the U.S. Department of Labor, Bureau of Labor Statistics, the U.S. Department of Commerce, Bureaus of Economic Analysis and Census, Mortgage Insurance Companies of America, and Freddie Mac.

There sources generate many currently-available variables that contain economic information. Several of these variables may be chosen for inclusion in the inventive model. Some of these variables are, for example, the following:

RFA/Economy.com Economic Variables

Diversity Diversity Rate

UNEM Actual unemployment rate

PER6YR Permit change divided by prior 6 year average

EMP4YR Total employment compounded growth over 4th prior year

PERM Actual permit numbers

PERMIT Permits divided by prior year

PERMHOUS Total permits divided by number of households

PERCONS Construction percent of total employment

WAGES Actual wage numbers

INCCHG Income change over prior year

RELWAGE MSA wages relative to US wages

PER2544 Percent of total population ages 25-44

TOTAL Total employment

ADJWAGE Actual wages adjusted for inflation

Mercer Claim and Delinquency Variables

CLAIM Ultimate claim rate

DEL1YR Delinquency rate for 1 year old book

DEL2YR Delinquency rate for 2 year old book

DEL3YR Delinquency rate for 3 year old book

DELINF Inforce delinquency

DELDIF Inforce delinquency minus prior year

NEWINS New insurance written in that quarter

POLORIG Number of policies originated in that quarter

Other Sources

HPI Home Price Index (OFHEO)

POPDENS Total population divided by the total land area for an MSA

MIGIN Migration by % of inbound shipments from the van lines

CPICHG The percent increase of the CPI from 4 quarters ago

RATE The US average interest rate

RATECHG The percent increase of the interest rate from 4 quarters ago

As described below, the inventive index model 120 analyzes variables such as these to determine if they satisfy the mean reversion principle. If they do, the variable is a candidate for use as one of multiple variables for ranking and rating MSAs. In the description below, seven variables are selected.

In the inventive index model 120, each MSA (the sectors and overall) is ranked on a scale of from “1” (“best risk”) through M (“worst risk”), where M is the total number of MSAs being ranked. M may be, for example, 200 or 250 MSAs. The ranking of the MSAs is converted to a rating for an MSA on scale of “1” to “10” (or more generally on a scale of 1 to N, where N is an integer greater than 1) by separating the N MSAs into 10 buckets or levels. The N MSAs are distributed, substantially evenly, across the “1” to “10” scale. As described below, in one embodiment, a market trend rating (i.e., the direction of the market from a prior quarter to the current quarter) may also be determined for a particular MSA and rated on a scale of “1” to “10”. The index scores for the MSAs are included in a report that may be made available in paper form 120 or electronically, such as over the Internet 121.

The rankings and ratings of the present invention rely on the concept of the exponential moving average (EMA). The EMA approach is widely used in the stock markets to determine certain trigger points in pricing at which one should buy or sell a particular stock. The EMA may be used to determine which variables satisfy a mean reversion tendency to remain at, or return over time to a long-run average level. For example, rates of return on stocks are mean reverting in that they may be high or low from one year to the next, but over time they tend to average 10-12%. In calculating a moving average, an EMA gives a greater weight to the most recent value of the variable for which the average is calculated than to previous values to account for a time lag in the change of the variable.

The inventive index rating likewise seeks to represent variables used as indicators of the MSAs' economy that satisfy the mean reversion tendency. To this end, the particular variables that are selected to be used in generating the scores for the economic sectors and the MSAs are therefore determined by calculating the Exponential Moving Average (EMA), the difference (DIFF) based on the EMA, and a correlation of the EMA and DIFF to a Cumulative Claim Rate. The trigger points in the inventive model are the points at which the variable is likely to drastically change such that the risk level swings from one extreme toward the other.

One equation for calculating the Exponential Moving Average is as follows:

| | |
|---|---|
| (1) | Current EMA (2/(n + 1)) * Current Value) + |
| | ((n − 1)/(n + 1) * Previous EMA). |

where “Current EMA” is the EMA calculated for the current quarter, the “Previous EMA” is the EMA calculated for the previous quarter, and the “Current Value” is the actual current value of the variable. It has been found through back-testing that to obtain the best results in the present invention, equation (1) should be performed for a 12-quarter lag, i.e. where n=12, for determining the trigger points at which the selected variables are most likely to change in value.

The difference DIFF between the current EMA and the current value of the variable used to calculate the Current EMA is then calculated using equation (2):

| | |
|---|---|
| (2) | Current DIFF = [Current Value/Current EMA] − 1 |

The DIFF value of the variables is used to rank an MSA by sector and also to determine the trigger points at which a particular variable will markedly change.

Next, a univariate correlation analysis is performed to compare the ultimate mortgage delinquency claim rate (e.g., as provided by Mercer) and the EMA and DIFF values of each potential variable that is being considered for use in calculating the inventive index. The claim rate CCR or Cumulative Claim Rate is determined using equation (3).

| | |
|---|---|
| (3) | CCR = [Cumulative Claims (in $)/ |
| | Total Mortgage Originations (in $)] |

Table I illustrates the results of the univariate correlation analysis for some of the variables set forth above.

TABLE I
Correlation of Claim Rate Versus (EMA and DIFF) Variables.

| Variable | Correlation to Claim Rate |
|---|---|
| Delinfdiff | 0.47 |
| perpop2544ema | 0.43 |
| Hpiema | 0.37 |
| Mapermema | 0.36 |
| Deldifema | 0.35 |
| Newinsema | 0.35 |
| Densityema | 0.35 |
| Relaffema | 0.33 |
| Sfpermema | 0.33 |
| Incomeema | 0.34 |
| Del1yrema | 0.34 |
| perpop2544diff | 0.31 |
| Totempema | 0.32 |
| Incomediff | 0.32 |
| Newinsdiff | 0.31 |
| Unempema | 0.29 |
| Totempdiff | 0.27 |
| Delinfema | 0.28 |
| Densitydiff | 0.27 |
| Totpopdiff | 0.27 |
| Mapermdiff | 0.27 |
| dellyrdiff | 0.27 |
| Unempdiff | 0.24 |
| Sfpermdiff | 0.24 |
| Migrationema | 0.23 |
| Relaffdiff | 0.23 |
| Hpidiff | 0.22 |
| Migrationdiff | 0.19 |
| Deldifdiff | 0.17 |

The variables are chosen to be representative of the four economic sectors of interest, and are selected to have a high correlation/weight between the EMA of the variable (and/or the DIFF of the variable) value of the variable and the mortgage delinquency claim rate. For example, the four segments and the 7 variables chosen are shown in Table II:

TABLE II

| Segment (Economic Sector) | Univariate | +/− | |
|---|---|---|---|
| and Variable | Weight | Correlation | Source |
| [1] Home Market: | | | |
| Home Price Index | .37 | Positive | OFHEO |
| (Hpiema in Table I) | | | |
| [2] Economy: | | | |
| Income | .34 | Positive | Economy.com |
| (Incomeema in Table I) | | | |
| Unemployment | .29 | Negative | Economy.com |
| (Unempema in Table I) | | | |
| Diversity Index | .28 | Positive | Economy.com* |
| [3] Delinquency: | | | |
| Delinquency Inforce | .47 | Negative | Mercer |
| (Delinfema in Table I) | | | |
| [4] Stability: | | | |
| Total Population | .35 | Positive | Economy.com |
| Percent 25-44 Year-olds | .43 | Positive | Economy.com |
| (perpop2544ema in Table I) | | | |

Originally done by University of Utah. Hachman Index, Bureau of Business of Economic Research

In Table II, a positive correlation indicates that the variable moves in the same direction as the mortgage delinquency claim rate. A negative correlation indicates that the variable moves in the opposite direction to the mortgage delinquency claim rate. The 12-quarter EMA is best for determining the trigger points of all the chosen variables for the MSA'S.

As one example of how the variables are selected, the variable HPI (defined as the Office of Federal Housing Enterprise Oversight's (OFHEO) Home Price Index) is tested to determine if it is mean reverting and if EMA is a good predictor of economic conditions. Several different EMA lag factors ranging from four quarters to 18 quarters were taken. The difference (DIFF) in the EMA and the HPI variable was calculated for all points and for all lag factors. After analysis, the DIFF of 12-quarter EMA matched up the closest with the yearly change of HPI. When the DIFF reached its 80-percentile (a trigger point), the UPI dropped within six to eight quarters. The opposite is true; whenever the DIFF went below its 20-percentile (another trigger point), then home prices rose. This indication was observed 30 out of 30 incidents.

After selecting the variables to use in calculating the Index, a similar multivariate correlation is determined using the EMA values of the variables to calculate the unique multivariate relation of each of these variables to the claim rate as a CCR or Cumulative Claim Rate defined in equation (3). This determines how much weight should be given to each variable in calculating a weighted overall score for the MSA. Table III indicates the weights that these selected variables are given under one set of calculations that used data for a particular 12 quarter period:

TABLE III

| | Multivariate | +/− | |
|---|---|---|---|
| Segment and Variable | Weight | Correlation | Source |
| [1] Home Market: | | | |
| Home Price Index | .25 | Positive | OFHEO |
| [2] Economy: | | | |
| Income | .11 | Positive | Economy.com |
| Unemployment | .09 | Negative | Economy.com |
| Diversity Index | .06 | Positive | Economy.com* |
| [3] Delinquency: | | | |
| Delinquency Inforce | .15 | Negative | Mercer |
| [4] Stability: | | | |
| Total Population | .04 | Positive | Economy.com |
| Percent 25-44 Year-olds | .32 | Positive | Economy.com |

Each of the MSAs is ranked by DIFF value for each of the 7 variables such that, for each variable, an MSA receives a rank on a scale of 1 to M, where M is the number of MSAs, e.g., M=200.

To rank an MSA across all four sectors, including Home Market, Economy, Delinquency and Stability, a “weighting” of the rankings of the 7 variables for the particular MSA is performed. The rank of each variable for this MSA is used to determine the rating of the MSA. A sum is taken of the rank of each variable multiplied by the respective multivariate weight to be given that variable, as shown in Table III, to provide an MSA's overall weighted score. Thus, to obtain an MSA score using the seven variables shown in Table III, the equation would be:

(4)
Weighted Score = (Home Price Index Rank * .25) + (Delinquency Rank *
.15) + (Total Population Rank * 0.4) + (Income Rank * .10) +
(Unemployment Rank * .09) + (Percent 25−44 Rank * .32) + (Diversity
Index Rank * .06)

The weighted scores for the MSAs are then compared, the MSAs are ranked by the weighted scores, and the ranked MSAs are divided into ten buckets so that they can be indexed on a scale of “1” to “10”. Where there are 200 MSAs, the rankings translate from rankings 1-200 to a score rating of 1 to 10 as shown in Table IV.

TABLE IV

| | Inventive Index |
|---|---|
| Rank | Score/Rating |
| 1-20 | 1 |
| 21-40 | 2 |
| 41-60 | 3 |
| 61-80 | 4 |
| 81-100 | 5 |
| 101-120 | 6 |
| 121-140 | 7 |
| 141-160 | 8 |
| 161-180 | 9 |
| 181-200 | 10 |

The score/rating calculated according to Table IV is used as the inventive Index for scoring/rating a particular MSA on a scale of 1 to 10. It should be understood that if there are more or less than 200 MSAs, whatever number of MSAs should be divided into 10 buckets as best as possible.

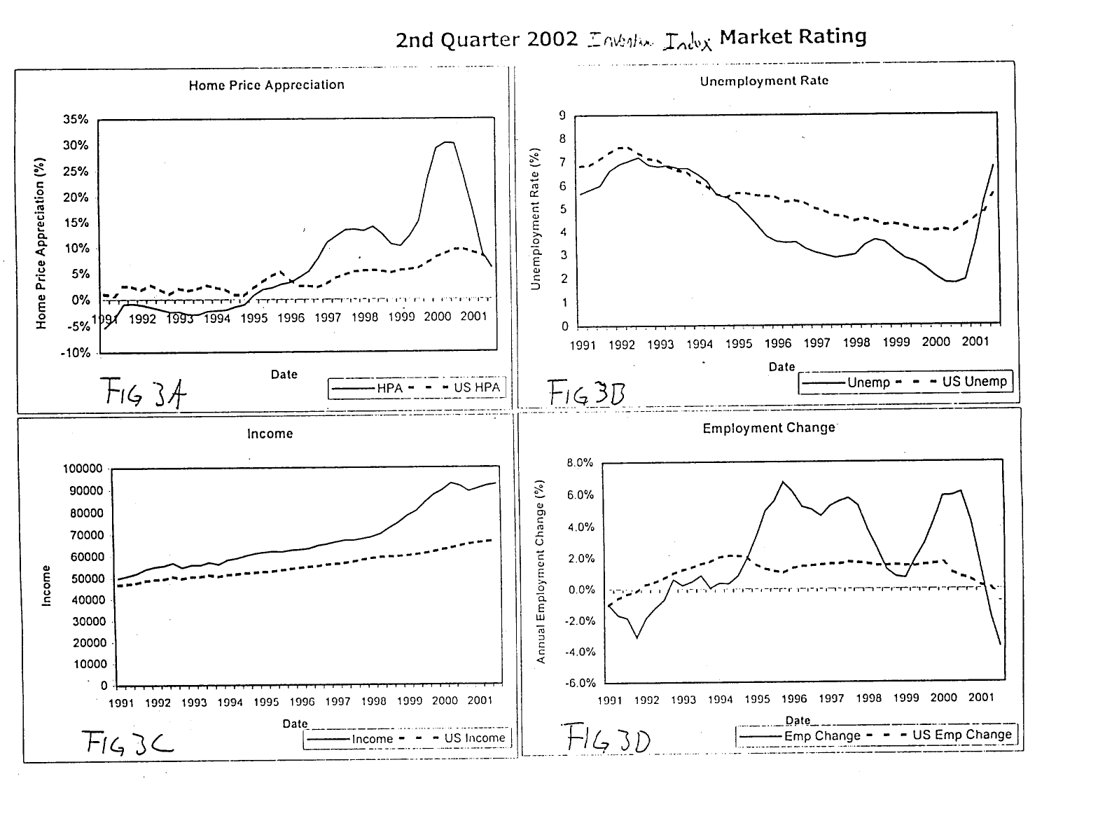

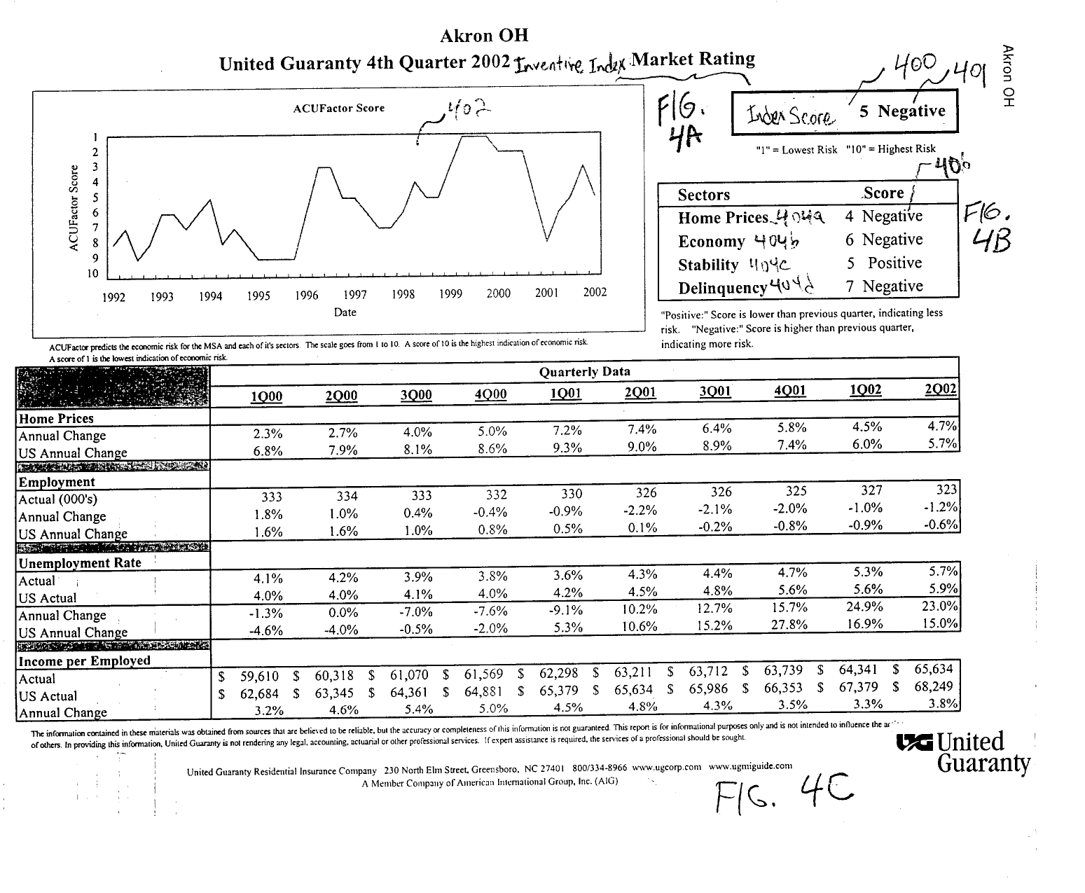

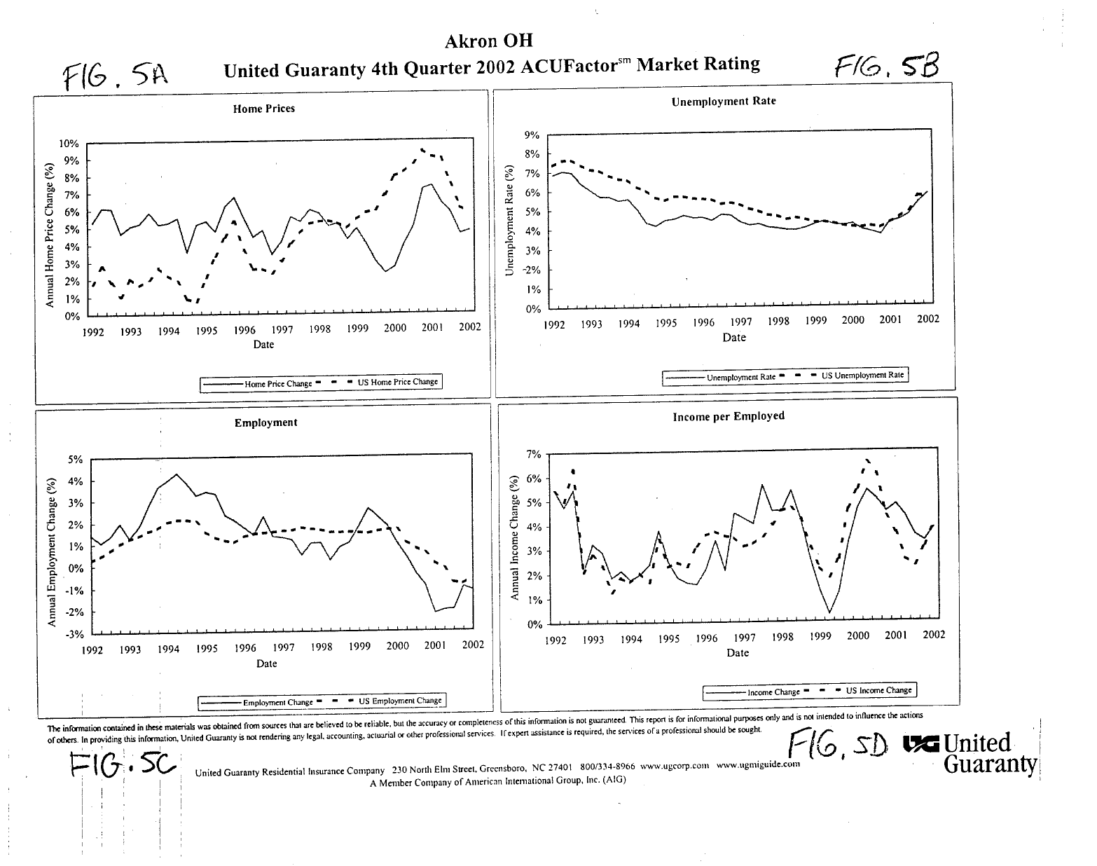

It is also generally desirable to rank the MSAs relative to one another by economic sectors. In ranking the MSAs by sector, the ranking of the sector is the same as the ranking of the variable(s) that comprise the such as Home Market or Delinquency that is represented by one variable. A rating for the economic sector may be calculated by converting the ranking to a rating using Table IV. For example, if an MSA ranked 162 for the Home Market sector, the home market rating would be “9.”

Where a particular sector is represented by multiple variables, such as in the “Economy” sector where 3 variables are taken into account as shown in FIG. 3, a weighted score is also calculated with respect to the variables in the particular sector using the multivariate weights of Table III as in equation (4). The sectors are then ranked using this weighted score and the ranking is converted into a rating using Table IV.

The inventive index may be used to make business decisions. Banks may use an MSA rating, for example, to determine whether to offer mortgages to customers within a particular MSA, or to determine a maximum dollar amount of mortgages to offer to customers within a particular MSA so it can limit exposure of the mortgage company to risk in the MSA, if necessary. Likewise, the index is also helpful to other businesses, e.g. insurers who provide mortgage insurance who may use the inventive Index to determine whether to offer insurance within the MSA or as a basis for determining the rates to charge for mortgage insurance.

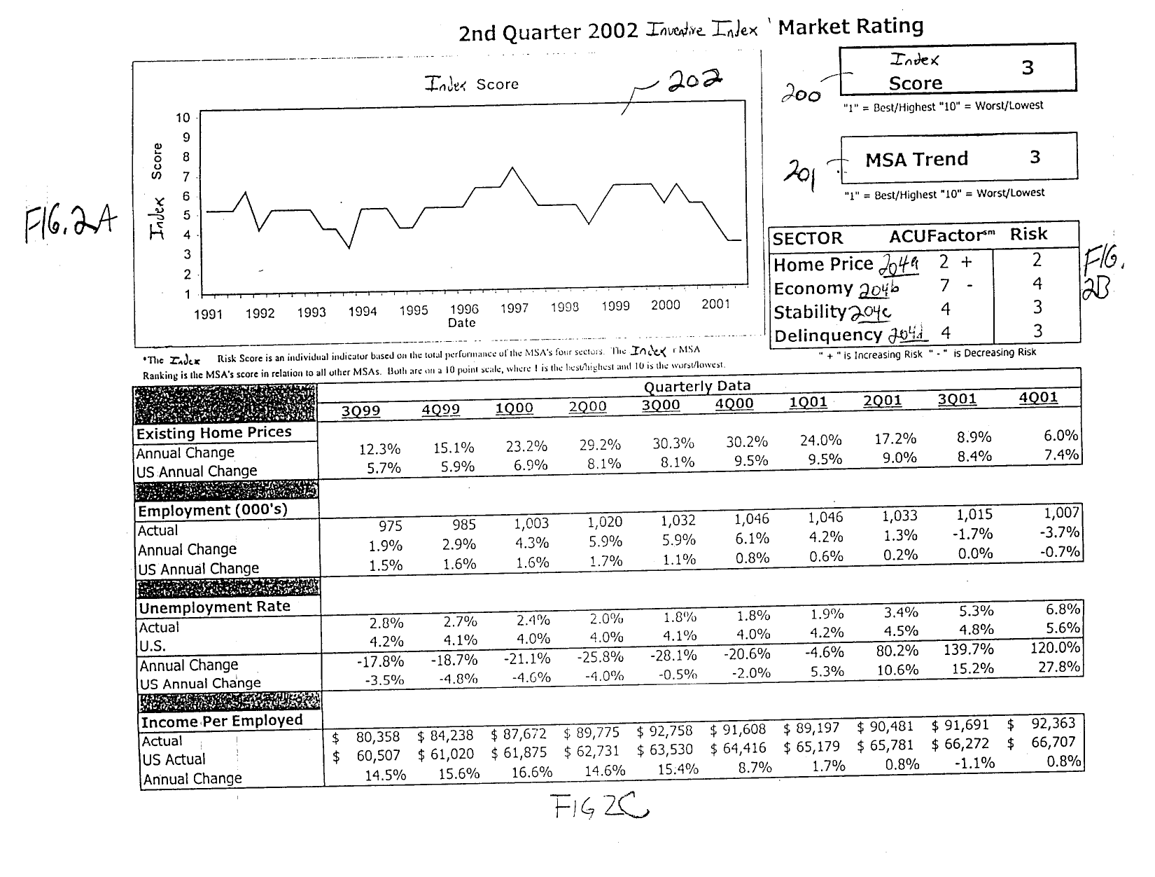

In a first embodiment, economic and market information for each leading Metropolitan Statistical Area (MSA) across the United States may be graphed as shown in FIGS. 2A to 2C and 3A to 3D. For each MSA reviewed, the following may be graphed:

(A) In FIG. 2A, a Index Market Rating including an Index score 200 is shown (which is the inventive Index score or rating across all four economic sectors, including home prices, local economy, demographic stability, and mortgage delinquency) and an MSA Trend value 201. FIG. 2A also includes historical ratings 202 for the Index Market Rating for the MSA for the past 10 years. This shows how the level of risk has changed over the past 10 years for MSA. If the slope of the graph is moving toward the top, then risk is decreasing. Likewise, if it is moving toward the bottom, then risk is increasing. The graph of historical ratings of the inventive Index helps better predict trends within the MSA.

(B) Current sector score/ratings 204a, 204b, 204c, 204d for each of the four economic sectors and rankings within an MSA (i.e., home price, economy) (See FIG. 2B) These sector scores may used with overall scores 200, 201 to project risk relativity for loans originated through the current quarter of publication. These sector ratings used in the inventive index model reflect the underlying strengths and weaknesses in an MSA that ultimately drive the MSA score.

Sector Ratings in FIG. 2B show the historical experience with defaults on mortgages that enables a mortgage company (i.e., a company involved in the mortgage industry) to identify several different economic and market situations associated with high defaults. The sector ratings show the underlying strengths and/or weaknesses of the sectors in an MSA that drive the resulting Index Market Rating, viz., Home Price, Economy, Stability, and Delinquency.

These Sector Ratings are multiplicative components of the Overall Rating. This means that the Overall Rating can be estimated by taking each of the four Sector Ratings multiplied by their associative weights and added together for the total rating as described above.

(C) The table in FIG. 2C illustrates a table showing the values of four components for the previous 10 quarters including

(i) home price appreciation in the MSA and U.S. as reported by OFHEO in its Repeat Sales Index, (ii) actual employment and annual percentage of employment change in the MSA and U.S. (including employment in the mining, construction, manufacturing, transportation/public utilities, wholesale/retail trade, financial/real estate, services, and government employment), (iii) unemployment rate in the MSA and U.S. (actual and annual percentage change), and (iv) income data per employed (total income, including income from employment, investments and transfer payments, divided by total employment) and annual percentage change in the MSA and the United States. This enables comparison of the MSA value to the nationwide average. See FIG. 2C.

(D) Graphs of data appearing in the table of FIG. 2C for the past 10 years. These graphs are shown in FIGS. 3A-3D. Each of these line graphs for each value in the table of FIG. 2C illustrate changes in the particular component.

FIG. 3A—MSA Home Price Changes vs. U.S. Home Price Changes: This graph compares the price changes for existing homes. If the metro area changes greatly exceed the U.S. changes, this may reflect a speculative bubble that may not be substantiated by the relative income increases within that MSA.

FIG. 3B—MSA Employment Growth vs. U.S. Employment Growth: A high employment growth rate within an MSA indicates a robust economy that may be accompanied by much housing activity. An excessively high growth rate may indicate the presence of speculative excesses, which often precede severe economic downturns. The U.S. employment growth rate serves as a benchmark, as it does in the next two graphs.

FIG. 3C—MSA Income Growth vs. U.S. Income Growth: High-income growth is needed to support high home price growth. When income growth stagnates, home price appreciation should also stagnate.

FIG. 3D—MSA Unemployment Rates vs. U.S. Unemployment Rates: Low unemployment rates often indicate a robust economy, while high rates indicate a stagnant or recessive economy. The change in the unemployment rate can also be used to monitor economic trends.

FIGS. 4A-4C and 5A-5D depict the report format according to a second embodiment of the present invention. This latter group of figures is similar to the earlier group of FIGS. 2A-2C and 3A-3D but in the latter figures the scores that are depicted show a single MSA score or rating. This rating may be the rating as determined with Table IV, meaning without a separate Market Trend score factored in. Alternatively, the displayed score may be the score as determined from Table VII with the MSA Trend score merged into the overall MSA score/rating.

In FIG. 4A, the Index score 400 is a “5” which means that the risk for this MSA is medium risk. Adjacent this score is an indicator 401 that is “negative,” which means that the score is higher than the previous quarter, indicating that the risk for this MSA has risen. (A “positive” indication would mean that the score 400 that is shown is lower than the score for the previous quarter, which would indicate that the risk has been reduced.). FIG. 4A also shows historical ratings 402 for the Index Market Rating for the MSA for the past 10 years. This shows how the level of risk has changed over the past 10 years for MSA. If the slope of the graph is moving toward the top, then risk is decreasing. Likewise, if it is moving toward the bottom, then risk is increasing. The graph of historical ratings of the inventive Index helps better predict trends within the MSA.

FIG. 4B shows the sector scores/ratings 404a, 404b, 404c, 404d for each of the four economic sectors within an MSA along with an indication 406 for each sector of whether the direction of this sector score is positive or negative.

The table in FIG. 4C, like the table in FIG. 2C, shows data for four components for the MSA and the United States for the previous 10 quarters:

(i) home price appreciation as reported by OFHEO in its Repeat Sales Index;

(ii) actual employment and annual percentage of employment change (including employment in the mining, construction, manufacturing, transportation/public utilities, wholesale/retail trade, financial/real estate, services, and government employment);

(iii) unemployment rate (actual and annual percentage change); and

(iv) income data per employed (total income, including income from employment, investments and transfer payments, divided by total employment) and annual percentage change.

Graphs of data appearing in the table of FIG. 4C for the past 10 years are shown in FIGS. 5A-5D, which show similar types of information as FIGS. 3A-3D. Each of these line graphs for each value in the table of FIG. 4C illustrate changes in the particular component. FIG. 5A depicts MSA Home Price Changes vs. U.S. Home Price Changes. FIG. 5B depicts MSA Employment Growth vs. U.S. Employment Growth. FIG. 5C depicts MSA Income Growth vs. U.S. Income Growth. FIG. 5D depicts MSA Unemployment Rates vs. U.S. Unemployment Rates.

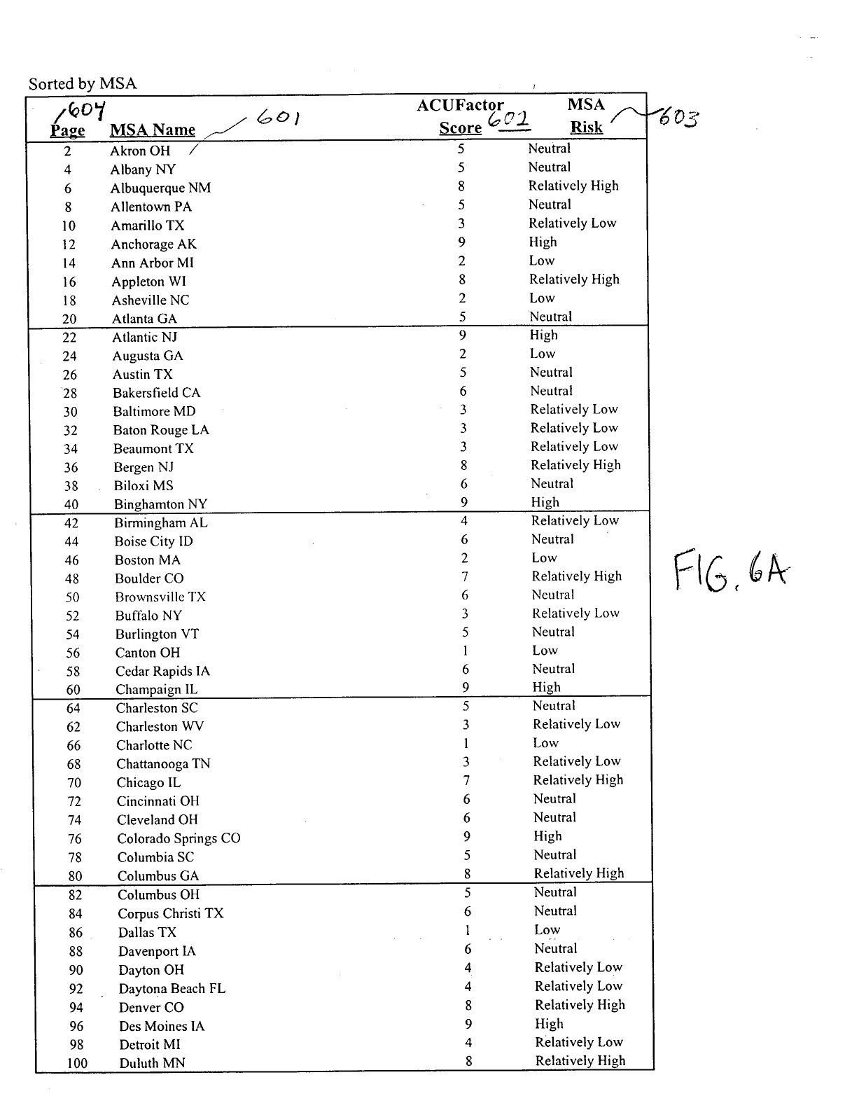

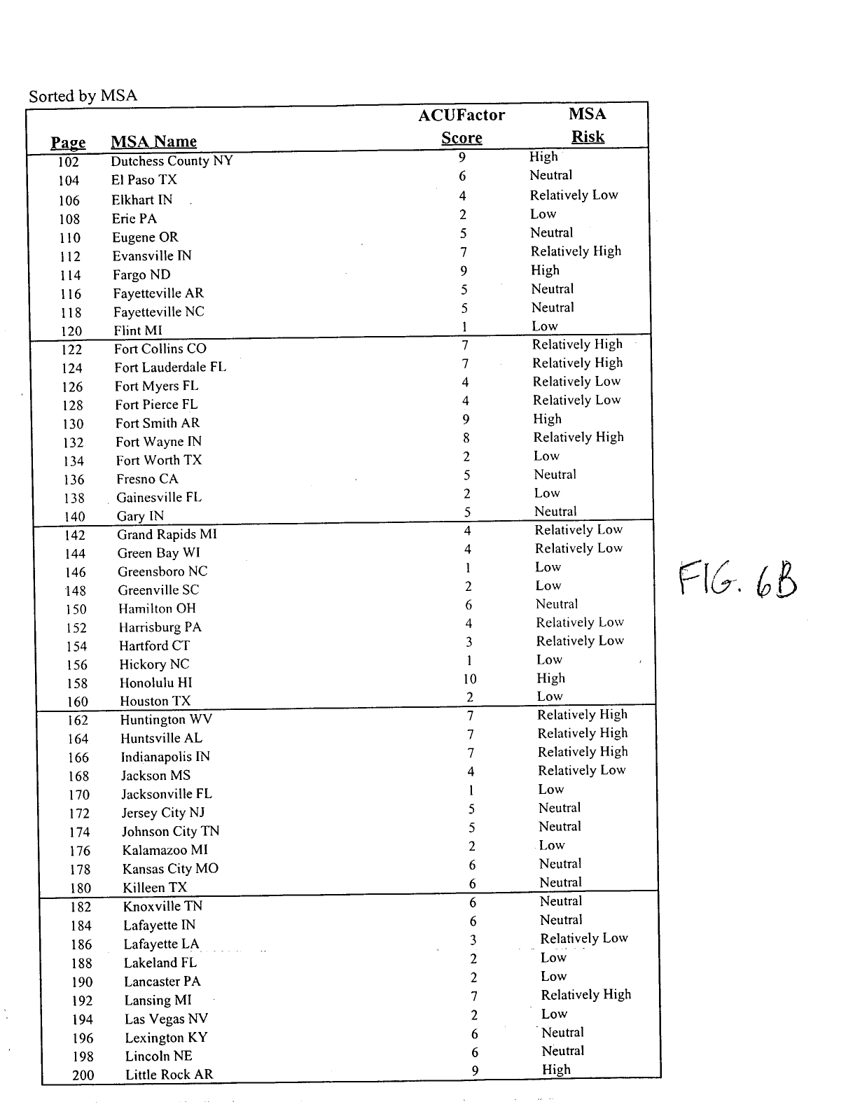

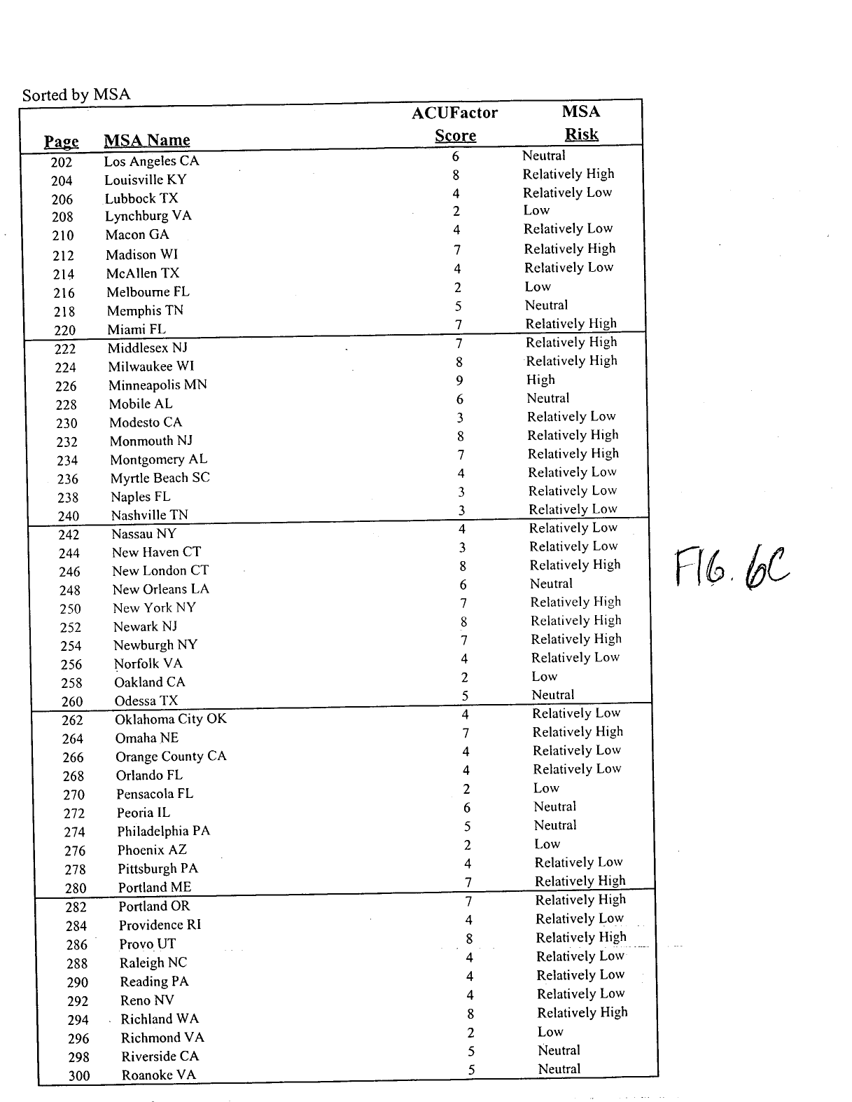

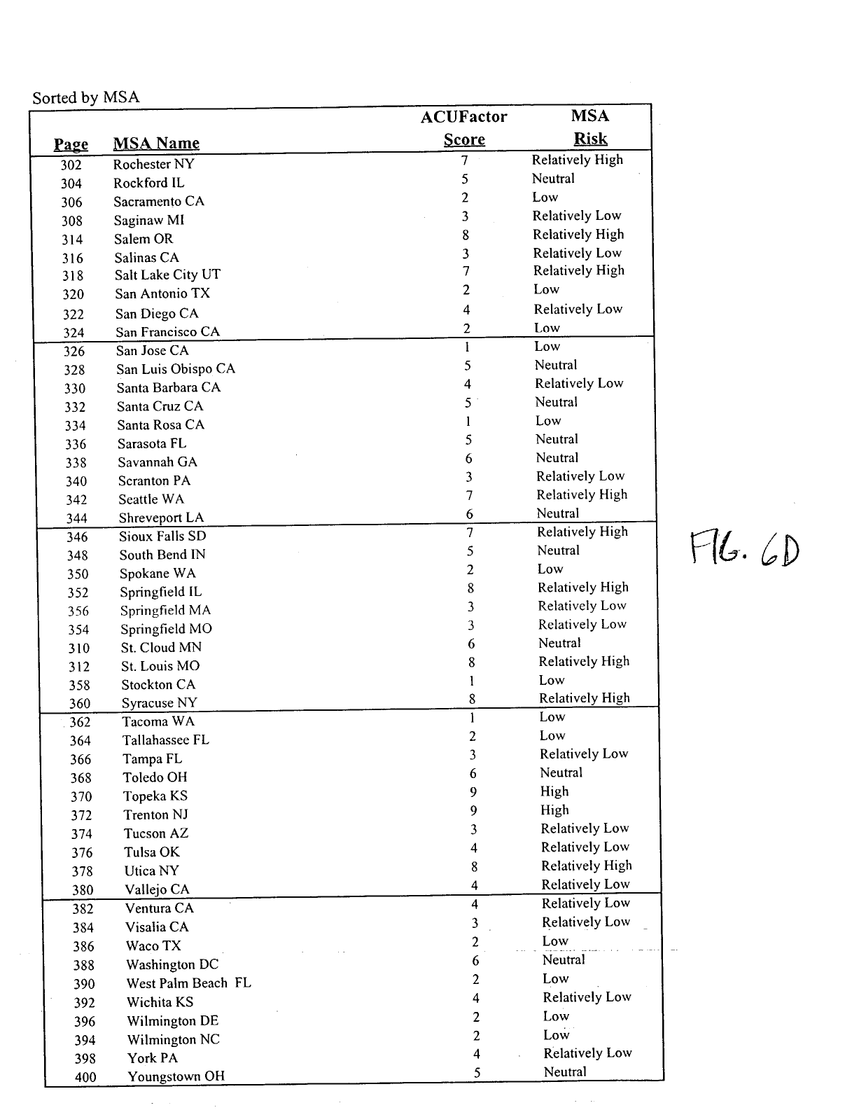

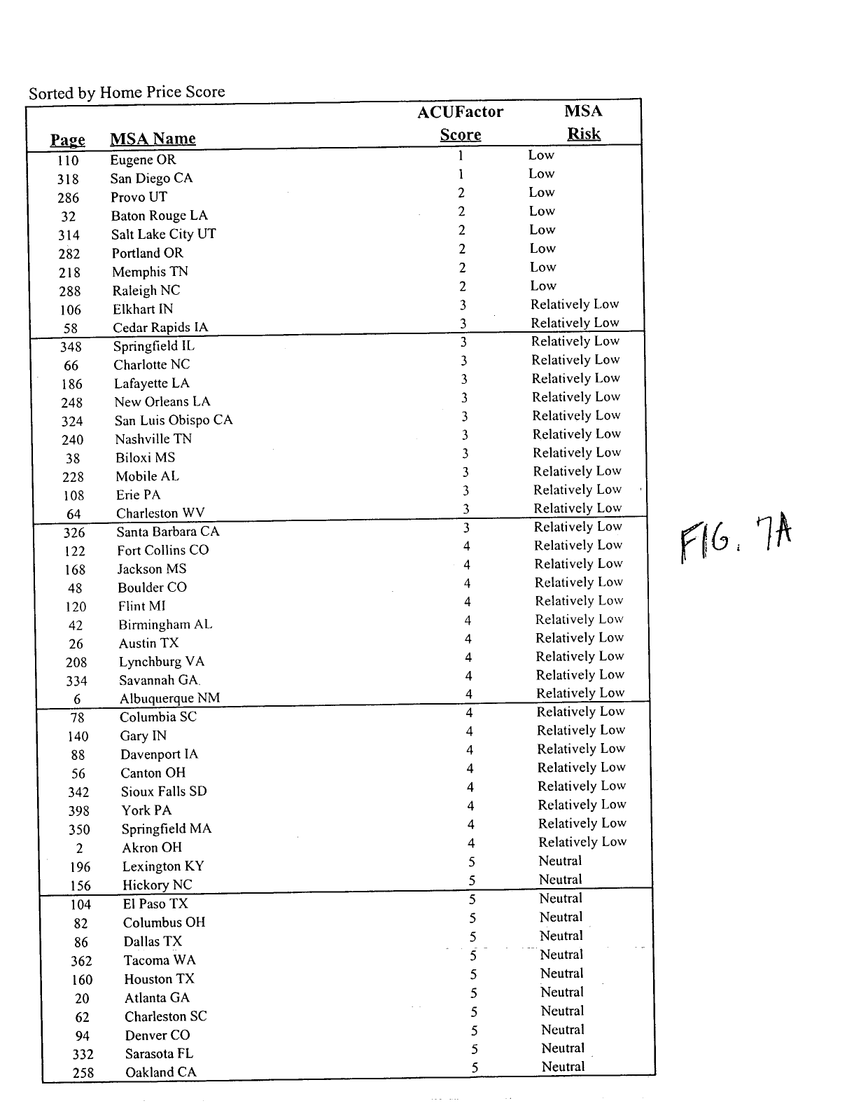

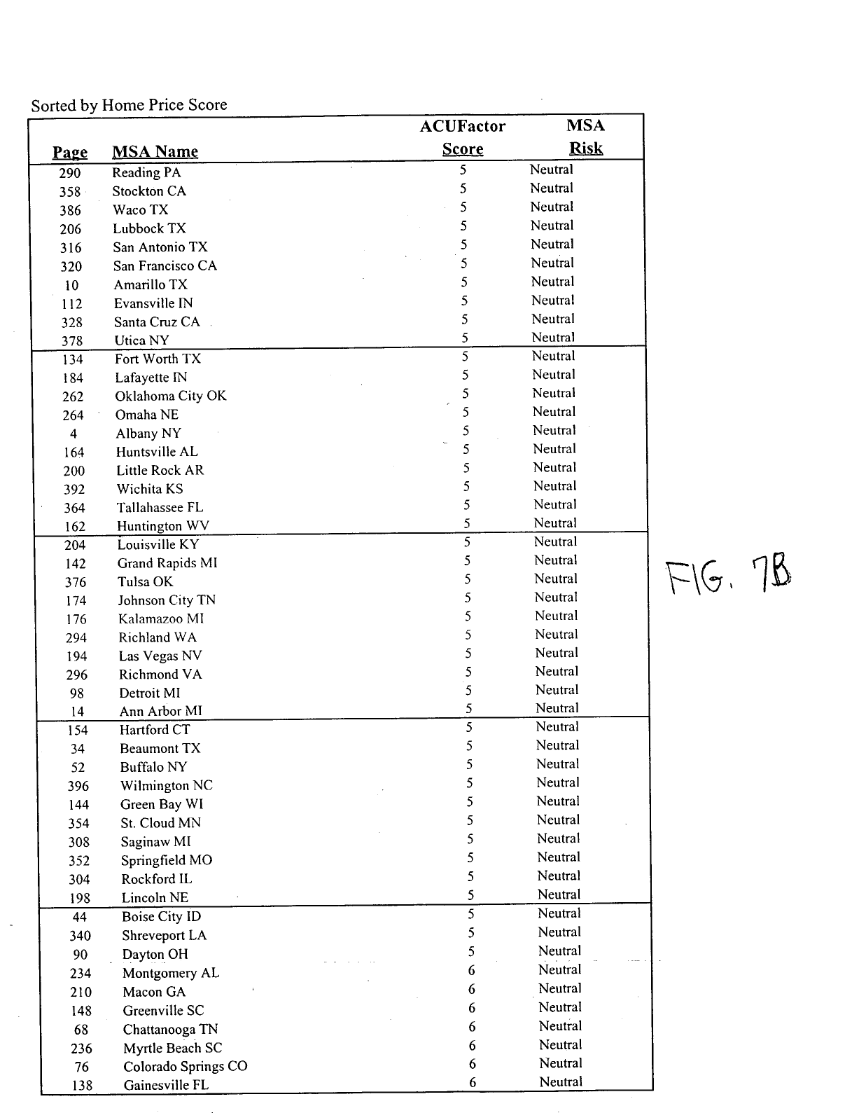

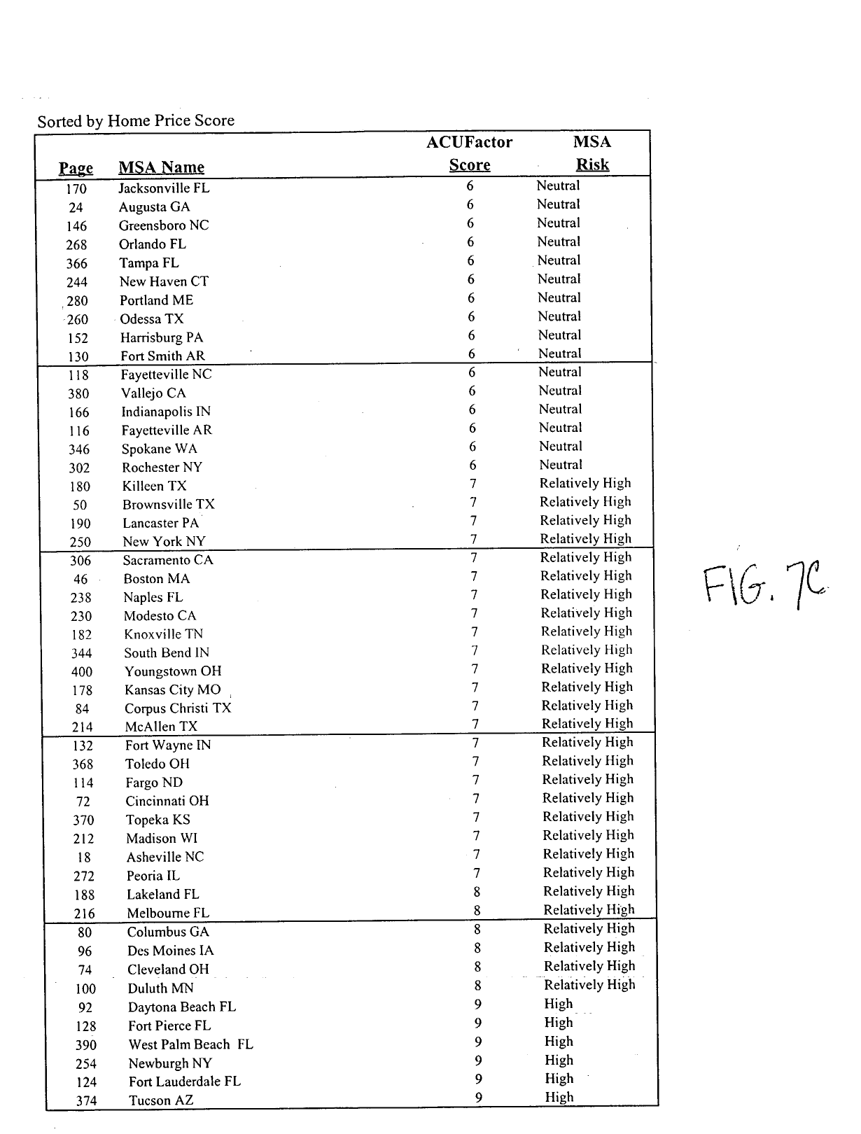

The Index scores for the MSAs and the level of risk represented by these scores may be presented in a table or listing. FIGS. 6A, 6B, 6C and 6D illustrate a listing alphabetically by name 601 of 200 MSAs, an overall Index score 602 for each listed MSA, the risk 603 represented by the score (e.g. 5=“neutral”, 8=“relatively high”). This listing may also serve as a table of contents to reports akin to those shown in FIGS. 4A-4C and 5A-5D for each MSA. Thus, a page number 604 may be indicated to refer to the page of the report where further information about the MSA is found.

It will be understood that there are alternative ways to list this information rather than listing the MSAs alphabetically. For example, the listing may be in the order of Index score (e.g., list begins with MSAs that have an index score of “1”, then “2”, etc.)

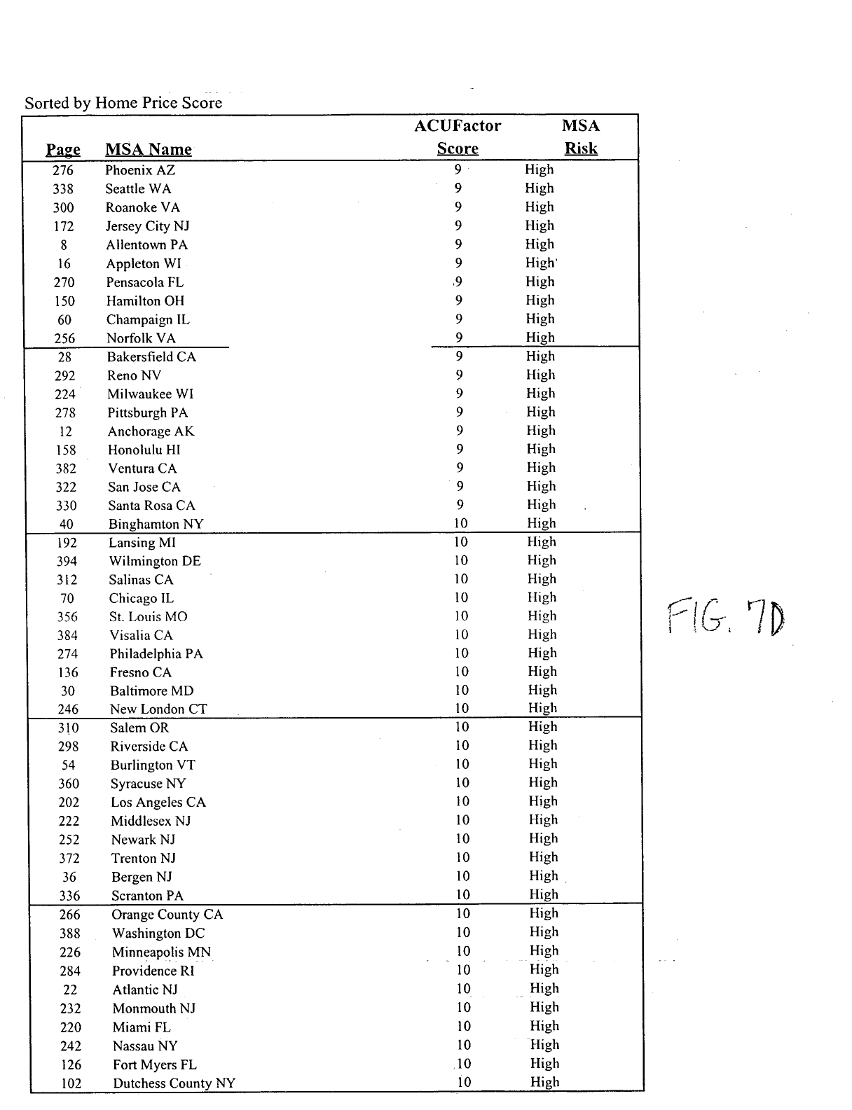

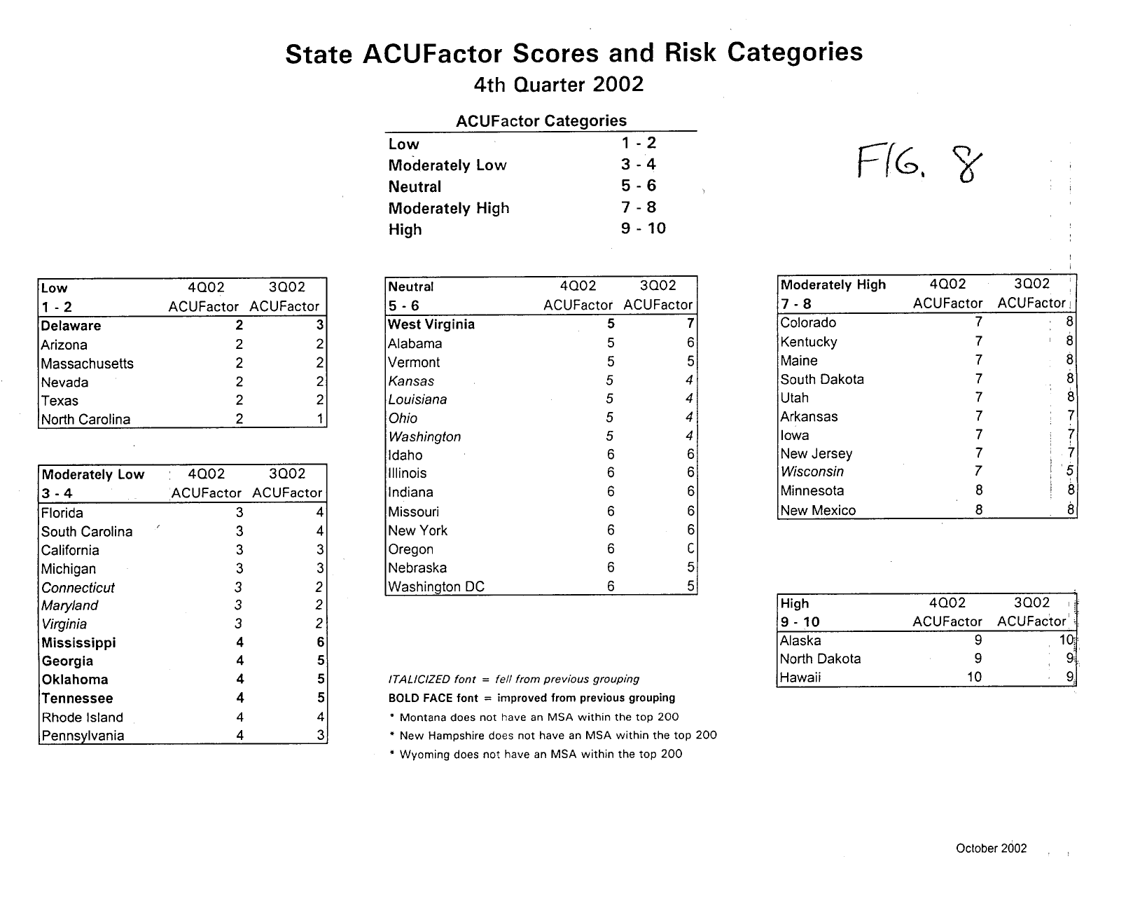

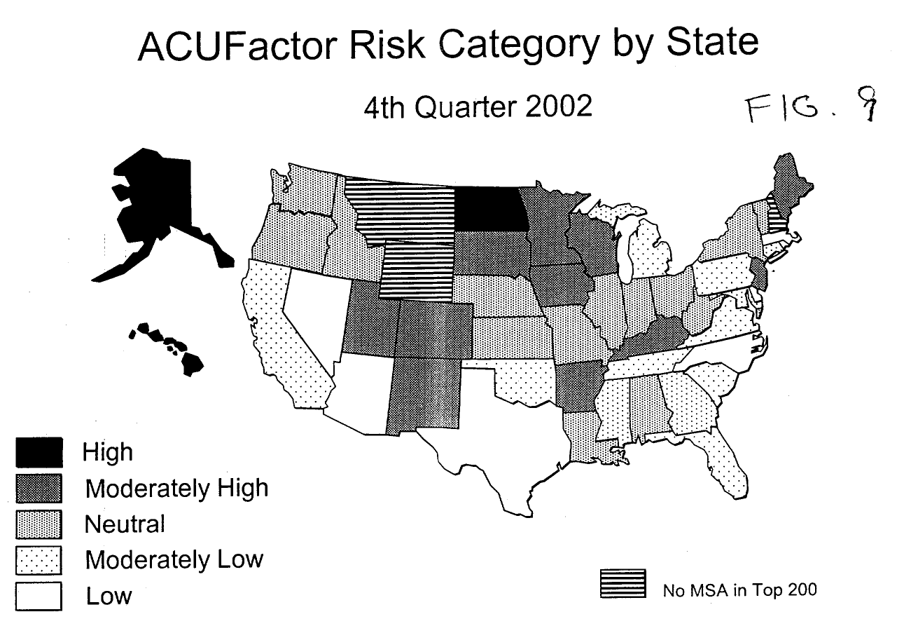

Just as the overall index score for MSAs may be listed, the scores for individual economic sectors, such as the four sectors mentioned above may also be illustrated. An example of a listing by Home Prices is shown in the listing of the index scores for 200 MSAs shown in FIGS. 7A-7D. This listing is by index score rather than alphabetical by MSA.

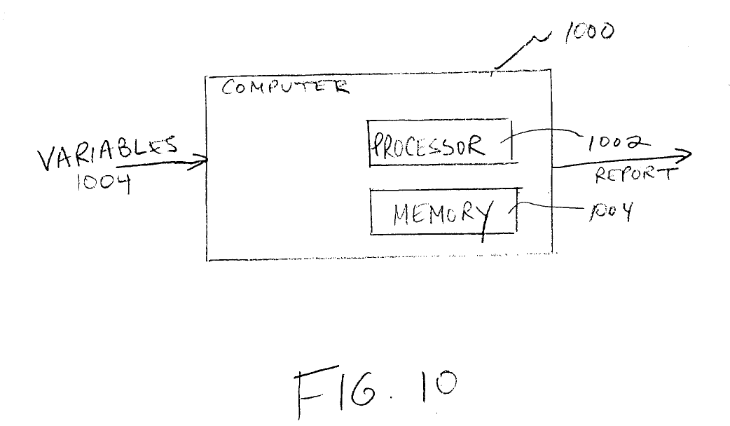

The index scores may also be determined for more consolidated regions or areas of a country (e.g., by state as compared to scores for each MSA). FIG. 8 shows tables in which an average of the index score is calculated for each state that has one or more MSAs by weighting index scores for MSAs in the state. States may be grouped with states that have comparable scores and compared with index scores for a previous quarter to analyze trends. These statewide scores may be mapped as in FIG. 9 to help understand these trends. As shown in this map, a state may not presently have an MSA, so that index scores for those states are not available.

FIG. 10 shows a computer 1000 that may be used to implement the inventive model of FIG. 1 in one embodiment of the invention. Computer 1000 (or multiple computers) may be used, for example, to determine the inventive Index score to rank and rate each MSA, and to generate a report that indicates the ratings for various MSA's. Computer 1000 has a processor 1002 for processing information that is input to the computer and generating an output. Inputs to the computer 1000 may include, for example, values needed to generate the overall score and sector ratings for each MSA. Processor 1002 determines the rankings of the MSA and translates the rankings of the MSAs into a rating on a scale of 1 to 10. Processor 1002 may also be used to calculate a Market Trend rating. Applications (e.g., Microsoft Excel) for generating the ratings and reports and the reports themselves may be stored in a computer memory 1004. Additionally, a Statistical Analysis Program (SAS) may be implemented on computer 1000 to determine the EMA and DIFF values of the variables to be weighted in calculating the inventive Index, the Cumulative Claim Rate, and the univariate and multivariate weights to be assigned to each variable. Computer 1000 may further comprise a server that is accessible through the Internet (not shown) to obtain access to reports about the ratings of the MSAs.

While there have been shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. It is the intention, therefore, to be limited only as indicated by the scope of the claims appended hereto.

What is claimed is:

1. A method for rating individual geographic areas relative to one another, said ratings reflecting economic risk in said geographic areas, the method comprising:
compiling data for a plurality of market-related variables that reflect multiple economic sectors of each of said geographic areas;
ranking said geographic areas relative to one another for each said variables;
generating a rating of one of said geographic areas on a scale of 1 to N, wherein said rating is a weighted average of said rankings of said variables for said one of said geographic areas, and wherein N is an integer greater than 1; and
generating a report for at least said one geographic area that indicates said rating for said geographic area, wherein said rating is usable as an indicator of market conditions for at least said one geographic area.

2. The method of claim 1, further comprising generating ratings for a plurality of said geographic areas, and including said ratings in said generated report.

3. The method of claim 2, further comprising consolidating said ratings from said geographic areas into a smaller number of ratings for consolidated groupings of said geographic areas.

4. The method of claim 1, wherein said step of ranking said geographic areas relative to one another comprises ranking said geographic areas on a scale of 1 to M, where M comprises the number of geographic areas being rated, grouping said M geographic areas relative to said ranking into N groups, and using said grouping to determine said rating of said one of said geographic areas.

5. The method of claim 1, wherein said step of ranking said geographic areas relative to one another comprises ranking said geographic areas for each variable based on a current DIFF value calculated for each of said geographic areas, wherein said current DIFF value=[Current Value of said variable/Current Exponential Moving Average]−1.

6. The method of claim 1, wherein said weighted average is calculated by
determining a multivariate weight for each of said variables relative to the other of said variables;
for each of said variables, multiplying said calculated multivariate weight for said variable by said ranking for said variable to obtain a set of values; and
adding said values together to obtain said weighted average.

7. The method of claim 1, further comprising using said rating as a measure of risk for said geographic area to determine whether or under what conditions to offer a loan in said geographic area.

8. The method of claim 1, further comprising generating a sector-by-sector rating for each of said economic sectors for said geographic areas.

9. The method of claim 1, wherein said economic sectors comprise home prices, local economy, stability, and mortgage delinquency rates.

10. The method of claim 1, wherein each of said geographic areas is a Metropolitan Statistical Area for which data is maintained.

11. The method of claim 1, further comprising choosing said variables for ranking said geographic area wherein said variables satisfy a mean reversion relationship.

12. The method of claim 1, wherein said variables represent home prices, mortgage delinquency, total population, demographic percentage of 25-44 years olds, income, unemployment rate, and industry diversity.

13. The method of claim 1, wherein at least one of said steps is performed using a processor.

14. A financial product for rating individual geographic areas relative to one another, said ratings reflecting economic risk in said geographic areas, the financial product being generated by the steps of:
compiling data for a plurality of market-related variables that reflect multiple economic sectors of each of said geographic areas;
ranking said geographic areas relative to one another for each said variables;
generating a rating of one of said geographic areas on a scale of 1 to N, wherein said rating is a weighted average of said rankings of said variables for said one of said geographic areas, and wherein N is an integer greater than 1; and
generating a report for at least said one geographic area that indicates said rating for said geographic area, wherein said rating is usable as an indicator of market conditions for at least said one geographic area.

15. The financial product of claim 14, wherein the financial product is further generated by generating ratings for a plurality of said geographic areas, and including said ratings in said generated report.

16. The financial product of claim 15, wherein the financial product is further generated by consolidating said ratings from said geographic areas into a smaller number of ratings for consolidated groupings of said geographic areas.

17. The financial product of claim 14, wherein said step of ranking said geographic areas relative to one another to generate the financial product comprises ranking said geographic areas on a scale of 1 to M, where M comprises the number of geographic areas being rated, grouping said M geographic areas relative to said ranking into N groups, and using said grouping to determine said rating of said one of said geographic areas.

18. The financial product of claim 14, wherein said step of ranking said geographic areas relative to one another to generate the financial product comprises ranking said geographic areas for each variable based on a current DIFF value calculated for each of said geographic areas, wherein said current DIFF value=[Current Value of said variable/Current Exponential Moving Average]−1.

19. The financial product of claim 14, wherein said weighted average is calculated by
determining a multivariate weight for each of said variables relative to the other of said variables;
for each of said variables, multiplying said calculated multivariate weight for said variable by said ranking for said variable to obtain a set of values; and
adding said values together to obtain said weighted average.

20. The financial product of claim 14, wherein the financial product is further generated by using said rating as a measure of risk for said geographic area to determine whether or under what conditions to offer a loan in said geographic area.

21. The financial product of claim 14, wherein the financial product is further generated by generating a sector-by-sector rating for each of said economic sectors for said geographic areas.

22. The financial product of claim 14, wherein said economic sectors comprise home prices, local economy, stability, and mortgage delinquency rates.

23. The financial product of claim 14, wherein each of said geographic areas is a Metropolitan Statistical Area for which data is maintained.

24. The financial product of claim 14, wherein the financial product is further generated by choosing said variables for ranking said geographic area wherein said variables satisfy a mean reversion relationship.

25. The financial product of claim 14, wherein said variables represent home prices, mortgage delinquency, total population, demographic percentage of 25-44 years olds, income, unemployment rate, and industry diversity.

26. The financial product of claim 14, wherein at least one of said steps is performed using a processor.
